(19) United States
(12) Patent Application Publication
(10) Pub. No.: US 2017/0313278 A1
(43) Pub. Date: Nov. 2, 2017

(54) Belt Pro

(71) Applicant: Ayenew Marew, Lancaster, PA (US)

(72) Inventor: Ayenew Marew, Lancaster, PA (US)

(21) Appl. No.: 15/649,713

(22) Filed: Jul. 14, 2017

Related U.S. Application Data
(63) Continuation-in-part of application No. 14/880,556, filed on Oct. 12, 2015.

(51) Int. Cl. B60R 22/12; B60R 22/00

(52) U.S. Cl. CPC B60R 22/12; B60R 2022/006

(57) ABSTRACT

An antimicrobial barrier seatbelt covering apparatus for preventing a cross contamination between hosts contacting with a seatbelt includes stripes of antimicrobial material creating a barrier against pathogens accumulated on a seatbelt, a container for storage of the antimicrobial material that can be attached on one end of the seatbelt, and a holding device to fix the material on the other end of the seatbelt. The antimicrobial seatbelt covering may be used in applications including seatbelts in cars seats, airplanes, boats where the seatbelt covering controls the level of cross contamination by preventing unwanted microbes that contact the seatbelt and thereby, prevents the spread of disease and infections.

### CROSS REFERENCE TO RELATED APPLICATIONS

This application is a Continuation-In-Part application for a utility application Ser. No. 14/880,556 filed on Oct. 12, 2015.

### FEDERALLY SPONSORED RESEARCH & DEVELOPMENT

Not applicable.

### MICROFICHE APPENDIX

Not applicable.

### BACKGROUND OF THE INVENTION

### (1) Field of the Invention

The field of the invention relates to covering devices, more particularly a new and improved vehicular and recreational antimicrobial seatbelt covering to minimize associated microbial infection through the seatbelt and buckle pair when exposed to various unhygienic environments.

### (2) Background of the Invention

The use of seatbelts is becoming more and more prevalent in today's world. This is particularly true in regard to motor vehicles, wherein seatbelts are required by law in all states. The seatbelt cover is generally wrapped around the shoulder belt and secured with fasteners. The majority of seatbelts in cars, buses, airplanes, boats, and amusement park attractions last for the life of the device and are contaminated by numerous pathogenic bacteria. Because traditionally seatbelts cannot be effectively cleaned as any other part of the vehicles or devices, seatbelts are heavily contaminated by pathogenic microorganisms. Seatbelt contamination in public transport, rental vehicles, airplanes, and amusement park attractions results in the transmission of pathogenic microorganisms by hands of the passengers and users and is a very common route through which infection diseases may spread in the community.

Widespread attention has been focused in recent years on the consequences of bacterial contamination contracted by contact with common surfaces and objects. CN 200420009698 discloses a utility model related to a car purifier sterilization, particularly, to a set of negative ion air purifiers and ozone and ultraviolet disinfection Trinity products, mainly for the purification and sterilization of the inside of a car.

CN 201520912447 discloses a utility model with a miniature car germicidal lamp. The lamp can be issued with a specific wavelength range of ultraviolet light to achieve the purpose of disinfecting the vehicle,

U.S. Pat. No. 3,306,662 suggested a seatbelt attachment with perforations to provide a cooling or heating flow of air to the wearer and is designed to prevent perspiration spoilage of the person's clothing lying immediately below the belt. Attachment is accomplished by means of lacing or by use of a zipper.

U.S. Pat. No. 4,693,495, to Lapointe, similarly sets forth a comfort adding covering for securement overlying a seatbelt flexible portion to enhance the comfort of a user utilizing hook and loop fasteners to secure the cushion to the seatbelt.

U.S. Pat. No. 6,655,736 discloses an invention that relates to providing upholstery protection to seats through a temporary seat cover to protect from bacterial contamination.

However, seatbelts, an essential part of modern vehicles and devices, are not satisfactory protected from bacterial contamination because of numerous users in cars, buses, airplanes, boats, and amusement park attractions. There is a necessity for a seatbelt cover that provides a barrier to germs spreading and prevents contamination between hosts coming into contact with the seatbelt. It may be appreciated that there is a continuing need for a new and improved vehicular, airplane, and amusement park device seatbelt covering to overcome the problems of microbial transmission to the buckles and seatbelt during exposure to extensive contamination and which may be further compactly and readily secured on the seatbelt. The present invention substantially fulfills this need.

### SUMMARY OF THE INVENTION

The invention includes a seatbelt covering for a vehicular, an airplane, or amusement park attraction seatbelt wherein the covering may be readily and effectively secured onto the seatbelt and prevents germs spreading between the various users that come into contact with the seatbelts. As such, the general purpose of the present invention, which will be described subsequently in greater detail, is to provide a new and improved vehicular and recreational seatbelt covering that has all of the advantages of the prior art seatbelt coverings and none of the disadvantages.

The present invention comprises a seatbelt covering device that is attached to the each belt of the two or three point seatbelt system and is comprised of a roll holder device further comprising of two chambers, two disposable antimicrobial covering means dispensing from the chambers that cover whole length of the belts, and a clench device. The seatbelt is placed between the two parts of the roll holder device, forming a space for a protract means and a “sandwich” of two antimicrobial material layers that overlay the seatbelt from the top and a bottom sides. The outward ends of the top and the bottom layers can be pulled out of the roller holder device toward to the clench up the whole length of the belt and overlay the seatbelt from top and bottom sides and attached on the opposite side of the seatbelt with the clasp next either to the wall hanger or to the belt buckle lock. In one embodiment, the seatbelt antimicrobial covering material are soft, flexible material strips that cover the seatbelt buckles and the belts. Alternatively, an optional hook and loop fastener patch is securable to the clasp and buckle portions of the seatbelt locking members to secure the covering to the associated clasp and buckle members.

It is therefore an objective of the present invention to provide a new and improved vehicular or recreational seatbelt covering that has all the advantages of the prior art seatbelt coverings and none of the disadvantages.

It is another objective of the present invention to provide a new and improved vehicular seatbelt covering that includes antimicrobial property which helps users to reduce the risk of spreading germs during the time when they are travelling.

It is a further objective of the present invention to provide a new and improved vehicular seatbelt covering that is of a durable and reliable construction.

Other features and advantages of the present invention will become more apparent from the following detailed description when taken in conjunction with the accompanying drawings, which illustrate, by way of example, the principles of the invention.

### BRIEF DESCRIPTION OF THE DRAWINGS

To further clarify various aspects of some example embodiments of the present invention, a more particular description of the invention will be rendered by reference to specific embodiments thereof, which are illustrated in the appended drawings. It is appreciated that the drawings depict only illustrated embodiments of the invention, and are, therefore, not to be considered limiting of its scope. The invention will be described and explained with additional specificity and detail through the use of the accompanying drawing, in which:

FIG. 1A depicts a roll holder device in the closed position.

FIG. 1B depicts the roll holder device in the open position.

FIG. 1C depicts the antimicrobial seatbelt covering apparatus clamped on a seatbelt at working position.

FIG. 2 depicts a cross section view of a clasp.

FIG. 3 depicts a schematic front view of two layers of antimicrobial material dispensing from a roll holder device with a seatbelt between them.

FIG. 4 depicts a cross schematic view of the invention for a three point seatbelt in the upper working position.

FIG. 5 depicts a three point seatbelt with the antimicrobial covering apparatus (car seatbelt).

FIG. 6A depicts a claps' upper position on a cross body seatbelt.

FIG. 6B depicts a roll holder device's position on the cross body seatbelt.

FIG. 6C depicts a low side claps' position of the clasp on a hip seatbelt.

FIG. 6D depicts a low side position of the roll holder on a hip seatbelt.

FIG. 7 depicts a two point seatbelt (airplane seatbelt) with the antimicrobial covering apparatus.

### DETAILED DESCRIPTION OF THE INVENTION

The usage of seatbelts for transportation and recreation increases every year. The use of seatbelts for personal and public transportation needs is required by law. The extensive use of rental cars, buses, airplanes, and recreational vehicles increases the chances of spreading an infectious disease among population. The present invention thus solves the problems associated with the protection of individuals from infection diseases spreading by touching and body contact with seatbelts.

While this invention is susceptible of embodiment in many different forms, specific embodiments are shown in the drawings and will herein be described in detail with the understanding that the present disclosure of such embodiments is to be considered an example of the principles, and is not intended to limit the invention to the specific embodiments shown and described. In the description below, like reference numerals are used to describe the same, similar, or corresponding parts in the several views of the drawings. This detailed description defines the meaning of the terms used herein, and specifically describes embodiments in order for those skilled in the art to practice the invention.

The terms “a” or “an”, as used herein, are defined as one as or more than one. The term “plurality”, as used herein, is defined as two as or more than two. The term “another”, as used herein, is defined as at least a second or more. The terms “including” and/or “having”, as used herein, are defined as comprising (i.e., open language). The term “coupled”, as used herein, is defined as connected, although not necessarily directly, and not necessarily mechanically.

Reference throughout this document to “one embodiment”, “certain embodiments”, “and an embodiment” or similar terms means that a particular feature, structure, or characteristic described in connection with the embodiment is included in at least one embodiment of the present invention. Thus, the appearances of such phrases or in various places throughout this specification are not necessarily all referring to the same embodiment. Furthermore, the particular features, structures, or characteristics may be combined in any suitable manner in one or more embodiments without limitation.

The following detailed description refers to the accompanying drawings that illustrate the embodiments of the present invention. Other embodiments are possible, and modifications may be made to the embodiments without departing from the scope of the invention. Therefore, the following detailed description is not meant to limit the invention. Rather, the scope of the invention is defined by the appended claims.

The present invention in one embodiment comprises a receptacle means, a protraction means, an antimicrobial means, and a clench means. “Receptacle” is meant permanently or temporally to hold or to store a substance inside in place sufficiently that the substance will not, under normal use, be separated from the receptacle unit. “Protract” means freely moves and extends upon applying force in a particular direction. “Antimicrobial” is meant as substance that is able to form a barrier for germs and to prevent the spreading and distribution of germs that cause infection diseases. “Clench” is meant to grasp the substance tightly in place for fixation in a certain position.

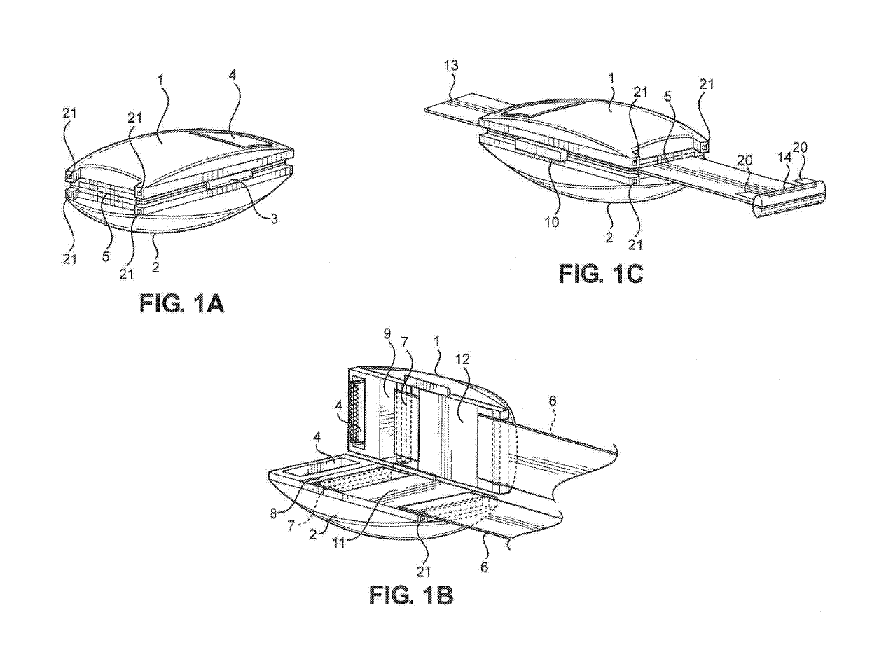

Referring to FIG. 1 A-C, the seatbelt antimicrobial covering apparatus comprises a receptacle means, a protract means, an antimicrobial means, and a clench means. A roll holder device, a receptacle means, a device keeps an antimicrobial material inside. As is shown in FIG. 1A, the roll holder device in closed position, the roll holder consisting of a top half 1 and a bottom half 2 connected by a hinge 3. A grip 4 inside the roll holder clamps the device to the seatbelt in working position and prevents sliding of the roll holder device over the seatbelt. On the opposite side to the grip, a slot 5 is formed by the top half 1 and the bottom half 2 of the roll holder for dispensing the protractive means—the seatbelt cover with two layers of antimicrobial material: an upper layer and a lower layer.

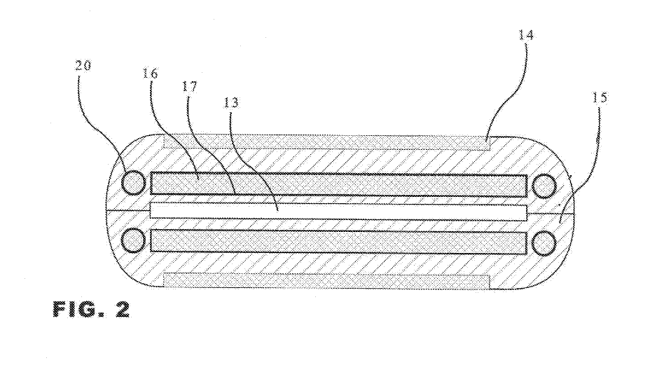

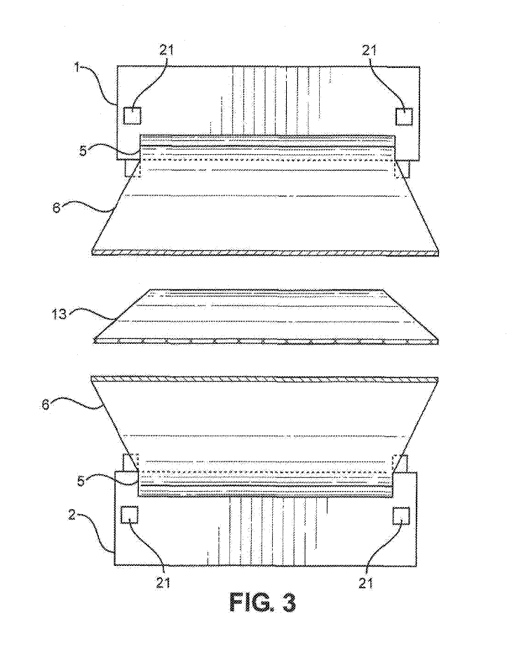

As shown in FIG. 1B-C, examples of protract means are represented by two layers of an antimicrobial material 6 wrapped around a top and a bottom rolls 7 that are placed into a low chamber 8 and a top chamber 9 inside the roll holder device. A lock 10 keeps the device in the closed position to secure the protractive means inside of the device. An upper divider 11 and a lower divider 12 hold antimicrobial material in the corresponding lower chamber and the top chamber and form a space for engaging the seatbelt 13 between the dividers. Upon applied force, the rolls freely turn inside of the chambers 8 and 9 discharge the antimicrobial material. Two layers of antimicrobial material move toward the direction of the applied force until a desired length of the material to completely cover the top and bottom seatbelt's surfaces are released through the slot 5. The seatbelt antimicrobial covering apparatus in closed working position is shown in FIG. 1C. The seatbelt 13 is placed between the top half 1 and bottom half 2 of the roll holder device, clamped on the seatbelt with the grip, and secured by the lock 10. Two layers of the antimicrobial material 6 are pulled from the chambers through the slot 5 and overlay the seatbelt 13 on the upper and lower surfaces. The “sandwich” of two antimicrobial layers and the seatbelt between them are placed inside a clasp 14 representing a clench means. As is shown in FIG. 2, the seatbelt 13 is placed between a top half 14 and a bottom half 15 of the clasp and two layers 16 of antimicrobial material are inserted to slots 17 inside the clasp. FIG. 3 shows a schematic front view of the protraction means, the “sandwich” formed by two layers of antimicrobial material 6 and a seatbelt 13 dispensing from the slot 5 formed by the top half 1 and the bottom half 2 of the roll holder device.

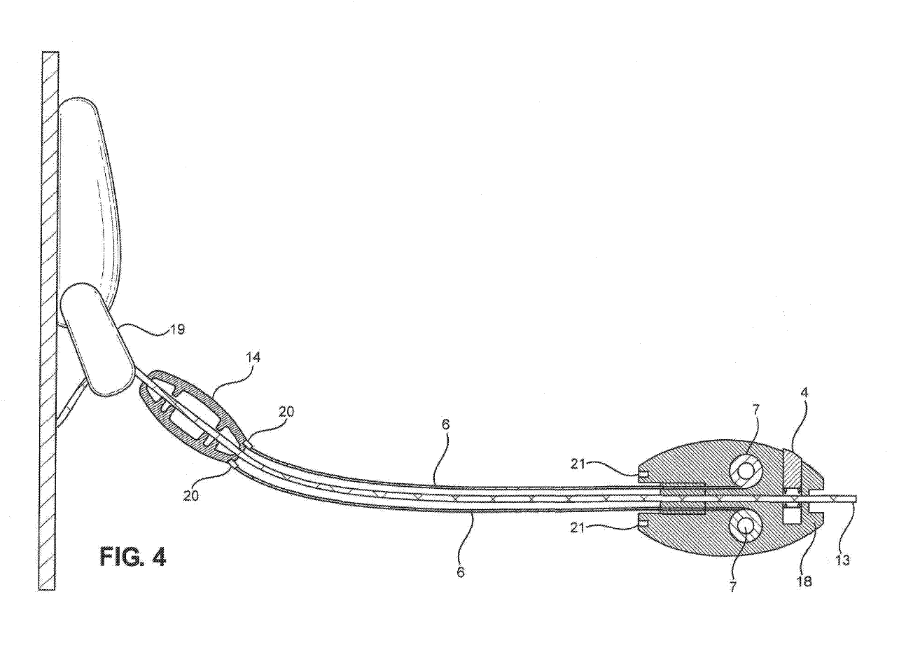

FIG. 4 shows the first invention embodiment: the seatbelt antimicrobial covering apparatus in the working position for the three point seatbelt in the car. The receptacle means, the roll holder device 18, is attached to the seatbelt at the very beginning of the seatbelt 13. The grip 4 clasps the device over the seatbelt. Two layers of the antimicrobial material 6 overlay the seatbelt from the top and bottom sides for the whole length of the seatbelt. The clench means, a clasp 14, holds all three layers of the protract means in the upper position close to the wall hanger 19 of the seatbelt. The steady fixation of the protract means in the upper position with the clasp and in the low position with the roll holder grip allows the antimicrobial material layers to be equally spread over the seatbelt surfaces and protects a traveler or customer from the contamination of the bacteria accumulated over the surfaces of the seatbelt. In the resting, non-working position, two place connecters 20 on the claps can be introduced to two corresponding apertures 21 on the roll holder device to keep the claps attached to the roll holder device in compact form.

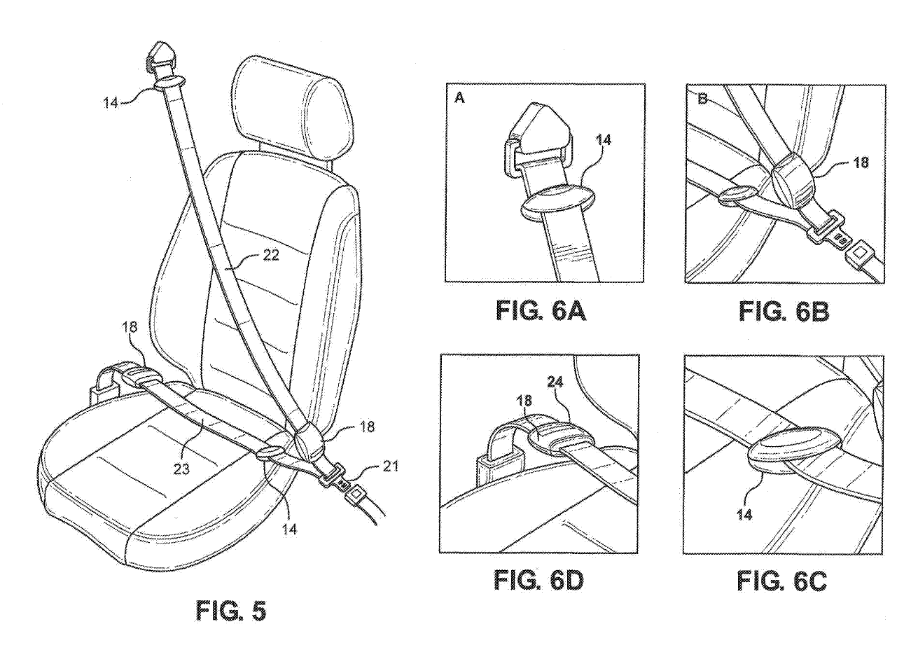

FIG. 5 shows a three point seatbelt, a car seatbelt, with the antimicrobial covering apparatus. The seatbelt has three points to attach to a seat or to the wall. The three point seatbelt has a buckle 21 that divided the belt between a cross body belt 22 and a hip belt 23. To provide full protection with the invention, two antimicrobial covering apparatus shall be used. A clench means 14 is placed on the upper cross body part of the seatbelt next to the wall hanger 19 of seatbelt in FIG. 6A; the roll holder 18 is attached next to the buckle in FIG. 6B. A clench means for the hip belt 19 clasp is placed next to the buckle in FIG. 6C, and the roll holder device 18 is secured by a grip next to the seatbelt connection 24 on the low side of the seat in FIG. 6D.

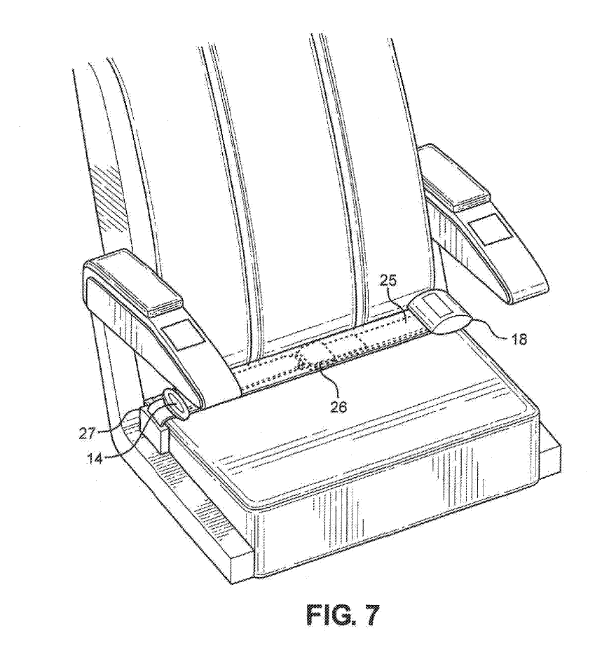

As shown in FIG. 7, the second invention embodiment, a two point seatbelt, airplane seatbelt, has only one hip belt 25 that requires only one antimicrobial covering apparatus. The airplane seatbelt has a belt connected by a buckle 26 lock in the middle. The roll holder device 18 is secured by the grip on one side of the hip belt next to the seatbelt connection with the seat, and two layers of the antimicrobial material are pulled out of the device passing through the airplane seat buckle and attached by the clasp 14 on the opposite side of the belt next to second connection point with the seat 27.

In particular, the invention is directed to antimicrobial seatbelt straps for covering that are formed from a combination of antimicrobial and flexible, soft substance materials. The flexible, soft substance materials may be formed from a cotton material that is be made with or treated with an antimicrobial agent.

In an embodiment of the invention, the antimicrobial agent has antimicrobial properties to effectively kill or hinder the growth of microbes, which includes but is not limited to viruses, bacteria, mold, fungi, mildew, yeast, and spores, thereby decreasing the spread of pathogens or germs. The seatbelt covering device is disposable so that after one time use it could be disposed of for the prevention of the spread of microorganisms.

It is to be understood that the above description is intended to be illustrative, and not restrictive. For example, the above-discussed embodiments may be used in combination with each other. Many other embodiments will be apparent to those of skill in the art upon reviewing the above description.

Plural instances may be provided for components, operations, or structures described herein as a single instance. Finally, boundaries between various components are somewhat arbitrary, and particular operations are illustrated in the context of specific illustrative configurations. Other allocations of functionality are envisioned, and may fall within the scope of the inventive subject matter. In general, structures and functionality presented as separate components in the exemplary configurations may be implemented as a combined structure or component. Similarly, structures and functionality presented as a single component may be implemented as separate components. These and other variations, modifications, additions, and improvements may fall within the scope of the inventive subject matter.

What is claimed is:

1. A antimicrobial barrier seatbelt covering apparatus for preventing a cross contamination between hosts contacting with a seatbelt comprising:
An upper layer and a lower layer of an antimicrobial barrier covering material preventing pathogen spreading between hosts;
a top roll and a bottom roll for storing of said antimicrobial barrier covering means;
a receptacle means for storage for said antimicrobial barrier covering means consisting of an top half and a bottom half connected by a hinge;
a protraction means for said antimicrobial barrier covering material that is formed by a upper divider, a lower divider, and two slots;
a pulling means for dispensing of said antimicrobial barrier covering material; and
a holding means for fixation of said antimicrobial barrier covering material on the seatbelt surfaces.

2. The apparatus of claim 1, wherein said material discharged from said upper layer roll covers an entire top seatbelt surface and said material discharged from said lower layer roll covers an entire bottom seatbelt surface of a seatbelt which placed between said upper layers and said lower layer of said antimicrobial barrier covering material.

3. The apparatus of claim 1, wherein said antimicrobial barrier covering material sterilizes, contains, and isolates pathogens.

4. The apparatus of claim 1, wherein said antimicrobial barrier covering material covers the seatbelt completely overlapping the seatbelt surfaces.

5. The apparatus of claim 1, wherein said antimicrobial barrier covering material are disposable and replaceable.

6. The apparatus of claim 1, wherein said receptacle means is a roll holder device for housing of said rolls having of a an upper chamber is formed by inner surface of said upper half and a upper divider and a lower chamber is formed by inner surface of said lower half and an lower divider.

7. The apparatus of claim 1, wherein said receptacle means having a lock and a hinge.

8. The apparatus of claim 1, wherein said upper divider, said lower divider, and said slots are forming a space for engagement of said antimicrobial barrier covering material and the seatbelt that placed between said upper and said lower layers of said antimicrobial barrier covering material.

9. The apparatus of claim 1, wherein said pulling means are outward ends of said upper layer and said lower layer of said antimicrobial barrier covering material can be pulled out of said roll holder device to cover completely a desired length of an upper and a lower seatbelt's surfaces released through said slot.

10. The apparatus of claim 1, wherein said holding means is a clasp for holding said pulling means attached to the seatbelt in any chosen position.

11. The apparatus of claim 1, wherein said holding means is attached to said receptacle means by connecters in non-working position.

12. A antimicrobial barrier seatbelt covering apparatus for preventing a cross contamination between hosts contacting with a seatbelt comprising:
an upper layer and a lower layer of a replaceable and disposable antimicrobial barrier covering material preventing pathogen spreading between hosts;
a top roll and a bottom roll for storing of strips of said replaceable and disposable antimicrobial barrier covering material that can be stored inside a container having an upper and a lower chambers connected by a hinge and a lock, wherein said container having slots to dispense by pulling of said strips outside of said container; and
a clasp for fixation of said antimicrobial barrier covering material on the seatbelt surfaces and providing equal distribution of said strips on the seatbelt surfaces.

13. The apparatus of claim 12, wherein said material discharged from said upper layer roll covers an entire top seatbelt surface and said material discharged from said lower layer roll covers an entire bottom seatbelt surface of a seatbelt which placed between said upper layers and said lower layer of said antimicrobial barrier covering material.

14. The apparatus of claim 12, wherein said antimicrobial barrier covering material sterilizes, contains, and isolates pathogens.

15. The apparatus of claim 12, wherein said antimicrobial barrier covering material covers the seatbelt completely overlapping the seatbelt surfaces.

16. The apparatus of claim 12, wherein said container is attached to said clasp by connecters in non-working position.
